(19) United States
(12) Patent Application Publication
(10) Pub. No.: US 2008/0088198 A1
(43) Pub. Date: Apr. 17, 2008

(54) Triple-phase brushless motor for a ceiling fan

(75) Inventor: Hsia-Yuan Hsu, Taichung City (TW)

Correspondence Address: BRUCE H. TROXELL, SUITE 1404, 5205 LEESBURG PIKE, FALLS CHURCH, VA, 22041, US

(73) Assignee: YONG SHIN T. ELECTRIC MACHINE CO., LTD.

(21) Appl. No.: 11/580,289

(22) Filed: Oct. 13, 2006

(51) Int. Cl. H02K 1/16; H02K 7/00; H02K 1/00; H02K 1/12

(52) U.S. Cl. 310/259; 310/67 R; 310/216; 310/180

(57) ABSTRACT

A triple-phase brushless motor for a ceiling fan includes a rotor and a stator made of compressed silicon steel sheets. The stator includes a central tubular shaft located at its center and bored with a sidewise hole at a preset position for plural wires to pass through, and plural wire wound sets located around its circumference with a number of three's multiple. Each wire wound set is wound by the wire with a preset number of turns via an automatic triple-phase winding means, which can be modified and revised from a conventional automatic winding means. Therefore, the stator can be not only easily made into a small size, but also consume less energy.

### BACKGROUND OF THE INVENTION

1. Field of the invention

This invention relates to a motor for a ceiling fan, particularly a triple-phase brushless one.

2. Description of the Prior Art

Commonly, a conventional ceiling fan is not only used as an indoor air-conditioner, but also an indoor decoration, almost a necessary household appliance for a family. Most of the conventional ceiling fans are still driven by a conventional squirrel-cage single-phase induction motor that is provided with a squirrel-cage rotor to drive blades of the ceiling fan. As shown in FIG. 1, in order to drive the squirrel-cage rotor of the single-phase induction motor, a squirrel-cage stator 1 is needed to be set inside the squirrel-cage rotor, so that plural starting coils 2 installed inside the squirrel-cage stator 1 can induce plural induction coils 3, set outside the squirrel-cage stator 1, and the squirrel-cage rotor to start rotating. But, the rated speed of the squirrel-cage rotor driven by the squirrel-cage stator 1 differs greatly with the practical one, causing some waste of energy owing to a very low operating efficiency.

### SUMMARY OF THE INVENTION

The objective of this invention is to offer a triple-phase brushless motor for a ceiling fan.

The main characteristics of the invention are a rotor and a stator made of compressed silicon steel sheets. The stator is composed of a central tubular shaft located at its center and bored with a sidewise hole at a preset position for plural wires to pass through, and plural wire wound sets located around its circumference with a number of three's multiple. Each wire wound set is wound by wire with a preset number of turns via an automatic triple-phase winding means. Therefore, the stator can be not only easily made into a small size, but also consume less energy for lengthening its life and saving energy. Also, a conventional automatic winding means can be modified and revised to become an automatic triple-phase winding means to wind the stator, saving a manufacturing cost too.

### BRIEF DESCRIPTION OF DRAWINGS

This invention is better understood by referring to the accompanying drawings, wherein:

FIG. 1 is a top view of a conventional stator of a motor for a ceiling fan;

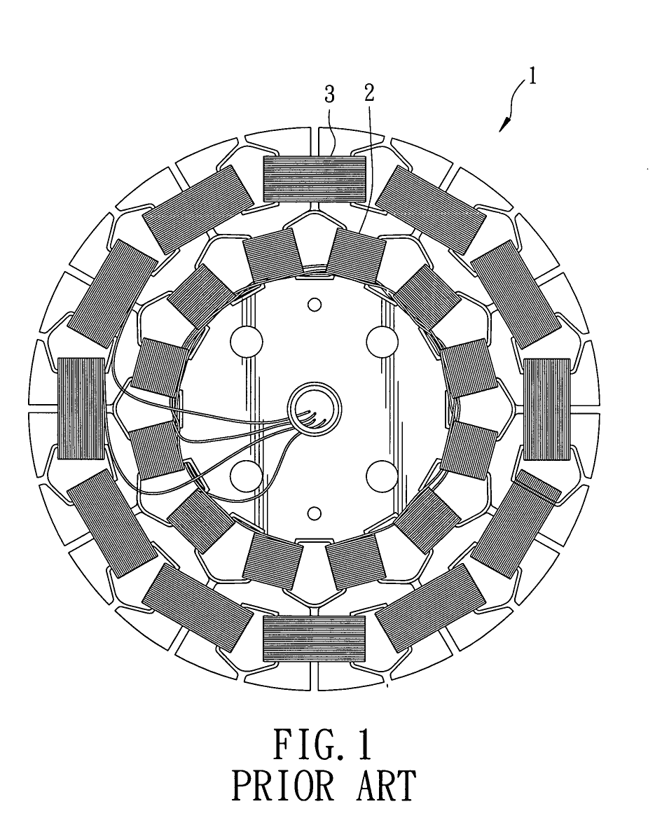

FIG. 2 is a perspective view of a stator of a preferred embodiment of a triple-phase brushless motor for a ceiling fan in the present invention; and

FIG. 3 is a top view of a stator of the preferred embodiment of a triple-phase brushless motor for a ceiling fan in the present invention.

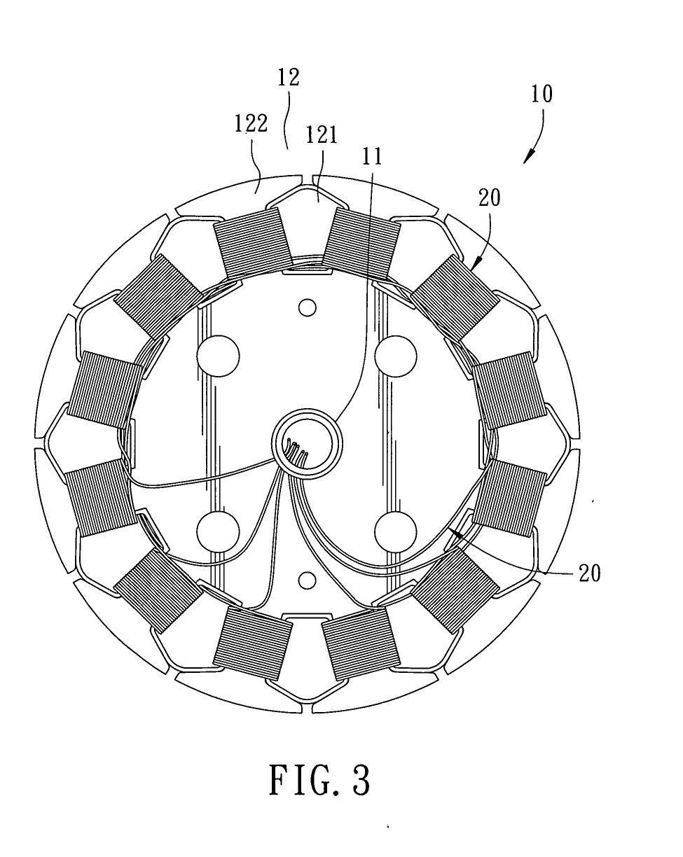

### DETAILED DESCRIPTION OF THE PREFERRED EMBODIMENT

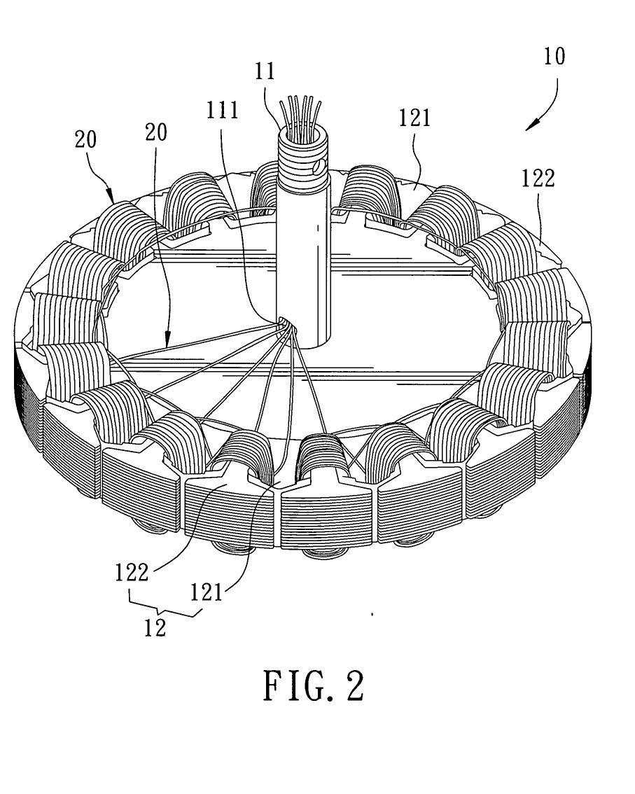

As shown in FIGS. 2˜3, a preferred embodiment of a triple-phase brushless motor in the present invention is provided with a rotor, a stator 10 and plural wires 20.

The stator 10, formed of a preset number of silicon steel sheets that are compressed to have a definite thickness, is provided with a central tubular shaft 11 located at its center, and bored with a sidewise hole 111 at a preset position for the wires 20 to pass through, and plural wire wound sets 12 located around its circumference with a number of three's multiple. Each of the wire wound set 12 is composed of a wire wound groove 121 cut inwards from the circumference of the stator 10 with a preset depth and a wire wound rod 122 wound by the wire 20 with a preset number of turns to have a definite thickness via an automatic triple-phase winding means. The wire 20 wound around the wire wound rod 122 is contained in the wire wound groove 121 and spaced apart with a proper distance without contacting each other.

Furthermore, as shown in FIGS. 2˜3, the radius and the thickness of the stator 10 can be altered in accordance with the size of the ceiling fan and a torque required. The wire wound groove 121 of the wire wound set 12 is formed of cutting inwards from the circumference of the stator 10 with a preset depth. The wire wound rod 122 extended with a preset length to separate the two adjacent wire wound grooves 121 is wound by the wire 20 with a preset number of turns, so that the stator 10 is able to obtain a preset torque to drive the blades of the ceiling fan to start rotating when initiated. The wire 20 wound around the wire wound rod 122 is contained in the wire wound groove 121 to have a definite thickness, and spaced apart with a proper distance without contacting each other. Also, the stator 10 can be wound by an automatic triple-phase winding means, which can be a conventional automatic winding means having being modified and revised, so it is n o t necessary to replace the conventional one with a new one.

The invention has the following advantages as can be seen from the foresaid description.

1. The triple-phase brushless motor for a ceiling fan in the present invention can operate effectively to save energy.

2. The wire 20 of the stator 10 can be wound by an automatic triple-phase winding means for shortening manufacturing time.

3. A conventional automatic winding machine for winding the stator of a conventional motor can be modified and revised to become an automatic triple-phase winding means used in the invention, able to save cost, too.

While the preferred embodiment of the invention has been described above, it will be recognized and understood that various modifications may be made therein and the appended claims are intended to cover all such modifications that may fall within the spirit and scope of the invention.

What is claimed is:

1. A triple-phase brushless motor for a ceiling fan comprising:
a rotor;
a stator provided with a central tubular shaft located at its center and plural wire wound sets located around its circumference with an amount of three's multiple, said central tubular shaft provided with a sidewise hole bored at a preset position for plural wires to pass through, each wire wound set provided with a wire wound groove cut inwards from a circumference of said stator with a preset depth and a wire wound rod wound by said wire with a preset number of turns to have a definite thickness via an automatic triple-phase winding means, said wire wound around said wire wound rod and contained in said wire wound groove and spaced apart with a proper distance without contacting each other.

2. A triple-phase brushless motor for a ceiling fan as claimed in claim 1, wherein said stator is made of a preset number of silicon steel sheets that are compressed to have a definite thickness for enhancing its torque.

3. A triple-phase brushless motor for a ceiling fan as claimed in claim 1, wherein said wires of said stator are wound around said wire wound rods of said wire wound sets via an automatic triple-phase winding means.
